(19) United States
(12) Patent Application Publication
(10) Pub. No.: US 2019/0346099 A1
(43) Pub. Date: Nov. 14, 2019

(54) Intelligent Solar Road Lamp With Charging Function For Municipal Use

(71) Applicant: Tianya Lou, Taizhou City (CN)

(72) Inventor: Tianya Lou, Taizhou City (CN)

(21) Appl. No.: 16/520,367

(22) Filed: Jul. 24, 2019

(30) Foreign Application Priority Data
May 10, 2019 (CN) 201910390667X

(51) Int. Cl. F21S 9/03; F21S 8/08; H02S 40/38; H02S 20/30; H02S 40/22

(52) U.S. Cl. CPC F21S 9/035; F21S 8/085; F21W 2111/02; H02S 20/30; H02S 40/22; H02S 40/38

(57) ABSTRACT

The invention discloses an intelligent solar road lamp with charging function for municipal use, including a lamp post 10 and a charging cavity 27 disposed in the lamp post 10. Charging electrodes 56 are symmetrically disposed in both end walls of the charging cavity 27. An inlet 28 and an outlet 26 are disposed in a first side wall of the charging cavity 27. First sliding holes 59 are symmetrically disposed in the both end walls of the charging cavity 27. The invention is able to adjust the angle of the solar panel, thereby improving the power generation efficiency of the device, and at the same time, the device is able to adjust the angle of the reflector panel, thereby adjusting the lighting area. The device is equipped with a charging device, which is able to conveniently provide charging rental service of the portable batteries.

### CROSS-REFERENCES TO RELATED APPLICATIONS

The present application claims priority from Chinese application No. 201910390667X filed on May 10, 2019 which is hereby incorporated by reference in its entirety.

### TECHNICAL FIELD

The present invention relates to the field of road lighting, in particular to an intelligent solar road lamp with charging function for municipal use.

### BACKGROUND OF THE INVENTION

When people use road lamp to illuminate the road surface, the fixed solar panel often leads to normal power generation efficiency. At the same time, the traditional road lamp is not able to adjust the illumination angle, which leads to that the illumination area is fixed. The general road lamp occupies a large amount of space but has a single function. Therefore, there is an urgent need for a kind of intelligent solar road lamp with charging function for municipal appliances to solve the above problems.

### BRIEF SUMMARY OF THE INVENTION

The present invention is to provide an intelligent solar road lamp with charging function for municipal use to solve the overcoming the above problems of the existing technology and improving the practicability of the equipment.

An intelligent solar road lamp with charging function for municipal use according to the invention comprises a lamp post and a charging cavity disposed in the lamp post; charging electrodes are symmetrically disposed in both end walls of the charging cavity; an inlet and an outlet are disposed in a first side wall of the charging cavity; first sliding holes are symmetrically disposed in the both end walls of the charging cavity; first sliding rods are disposed in the first sliding holes; first springs are elastically disposed between the first sliding rods and end walls of the first sliding holes; multiple groups of portable batteries are stacked on the first sliding rods; grooves with outward openings are disposed in both end walls of the portable batteries; contacting electrodes abutted against the charging electrodes 56 are disposed in the grooves; second springs are elastically disposed between the contacting electrodes and end walls of the grooves; power indicator lights are symmetrically disposed on front and rear end walls of the portable batteries; a color sensor is disposed in a rear wall of the charging cavity; a pushing block is disposed in the charging cavity; a sliding groove with an upward opening is disposed in a bottom wall of the charging cavity; a rack fixedly connected to the pushing block is disposed in the sliding groove; a first reset device is elastically disposed between the rack and an end wall of the sliding groove; a gear cavity is disposed in a first wall of the sliding groove; a first belt cavity is disposed in a rear wall of the gear cavity; a first rotating shaft is rotatably disposed between the first belt cavity and the gear cavity; a sector gear is fixedly disposed on a first tail end of the first rotating shaft in the gear cavity; a first pulley is fixedly disposed on a second tail end of the first rotating shaft in the first belt cavity; a rotating cavity is disposed in a top wall of the charging cavity; a second belt cavity is disposed in a rear wall of the rotating cavity; a second rotating shaft is rotatably disposed between the second belt cavity and the rotating cavity; a second pulley is fixedly disposed on a first tail end of the second rotating shaft in the second belt cavity; roller wheels are symmetrically disposed on a second tail end of the second rotating shaft in the rotating cavity; in use, the roller wheels rotate to push the portable batteries out of the outlet.

Preferably, a swing cavity is disposed in a bottom wall of the inlet; a ratchet cavity is disposed between the first belt cavity and the second belt cavity; a third rotating shaft is rotatably disposed between the first belt cavity and the ratchet cavity; a third pulley is fixedly disposed on a tail end of the third rotating shaft in the first belt cavity; the third pulley is in transmissive fit connection with the first pulley through a first belt; a fourth rotating shaft, which penetrates the second belt cavity, is rotatably disposed between the ratchet cavity and the swing cavity; a fourth pulley is fixedly disposed on an outer surface of the fourth rotating shaft in the second belt cavity; the fourth pulley is in transmissive fit connection with the second pulley through a second belt; a toggling rod is fixedly disposed on an outer surface of the fourth pulley in the swing cavity; a torsion spring is elastically connected between a front end of the fourth pulley and a front wall of the swing cavity; the fourth pulley in the ratchet cavity is connected to the third rotating shaft through a ratcheting device; in use, when the portable batteries are abutted against the toggling rod, the toggling rod rotates to a first side to provide power for a charging device.

Preferably, a stabilizing base is fixedly disposed on a bottom wall of the lamp post; a battery is disposed in the lamp post; a floodlight and a lampshade are fixedly disposed on a top wall of the lamp post; a transmission cavity is disposed in the lamp post; a worm, which is in power connection with a motor fixedly disposed in a bottom wall of the transmission cavity, is rotatably disposed in the transmission cavity; a fifth rotating shaft extending in front-rear direction is rotatably disposed in the transmission cavity; a worm wheel engaged with the worm is fixedly disposed on an outer surface of the fifth rotating shaft in the transmission cavity; front and rear tail ends of the fifth rotating shaft extend out of the lamp post, wherein swing rods are fixedly disposed on the front and rear tail ends of the fifth rotating shaft; a fixing plate is fixedly disposed between two of the swing rods in front-rear direction; a solar panel is fixedly disposed on a top wall of the fixing plate; a reflector panel is fixedly disposed on a bottom wall of the fixing plate; in use, the motor is started to rotate to drive the worm, the worm wheel, the swing rods and the fixing plate to swing, thereby adjusting an angle of the solar panel or the reflector panel.

The beneficial effects of the present invention are as follows: the invention is able to adjust the angle of the solar panel, thereby improving the power generation efficiency of the device, and at the same time, the device is able to adjust the angle of the reflector panel, thereby adjusting the lighting area. The device is equipped with a charging device, which is able to conveniently provide charging rental service of the portable batteries.

### BRIEF DESCRIPTION OF THE DRAWINGS

For better explain the technical proposal in the present invention embodiments or the prior art, the drawings to be used in the description of the embodiments or the prior art will be briefly described below. Obviously, the drawings in the following description are only some embodiments of the present invention. For those common technicians in this field, other drawings may also be obtained based on these drawings without any creative work.

FIG. 1 is the schematic structural diagram of the intelligent solar road lamp with charging function for municipal use in this invention;

FIG. 2 is the schematic diagram along “A-A” direction in FIG. 1;

FIG. 3 is the enlarged schematic structural diagram of “B” in FIG. 1;

FIG. 4 is the schematic diagram along “C-C” direction in FIG. 3;

FIG. 5 is the schematic diagram along “D-D” direction in FIG. 3;

FIG. 6 is the enlarged schematic structural diagram of “E” in FIG. 3.

### DETAILED DESCRIPTION OF THE INVENTION

All features disclosed in this specification, or all methods or steps in the processes disclosed, can be combined in any manner except for mutually exclusive features and/or steps.

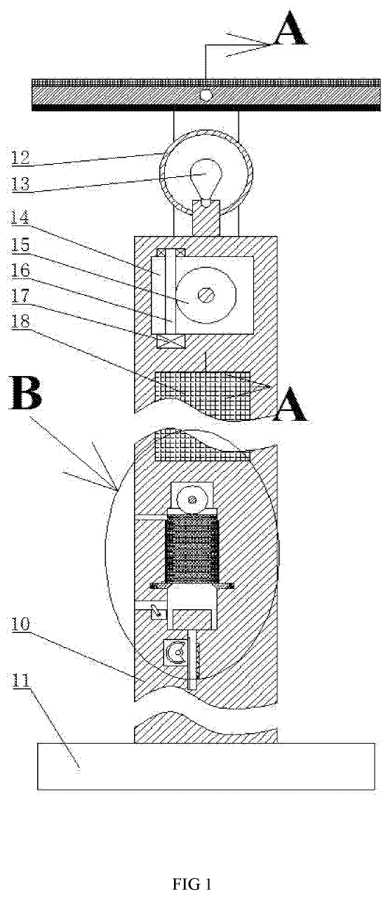

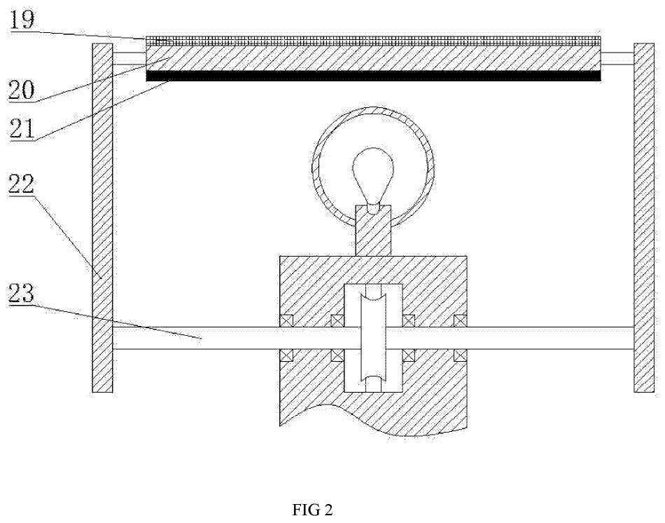

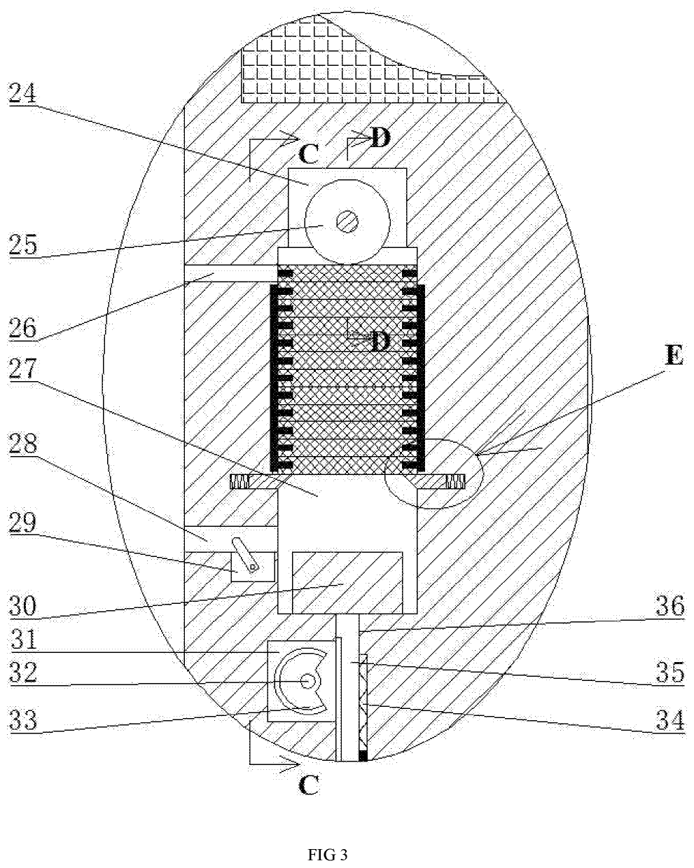

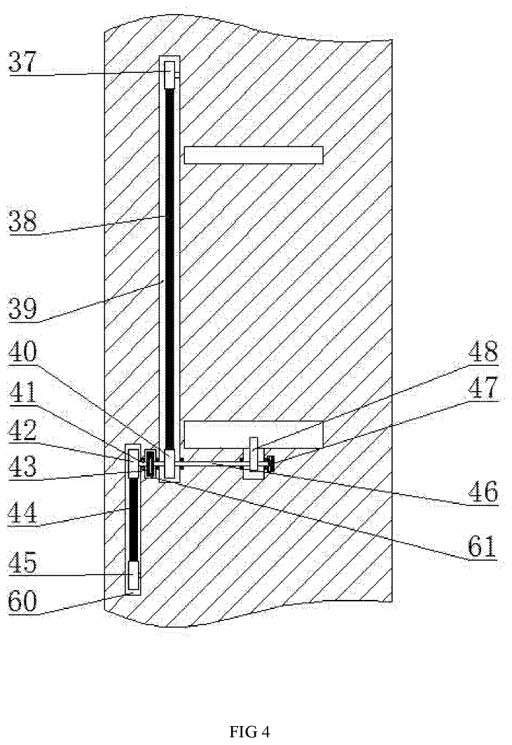

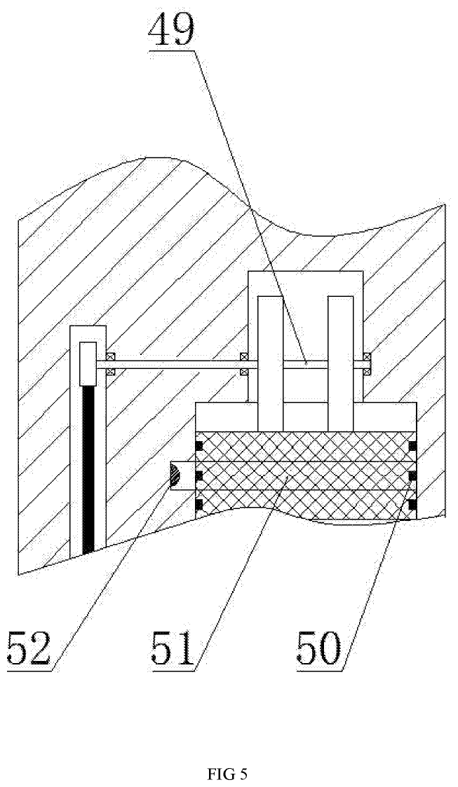

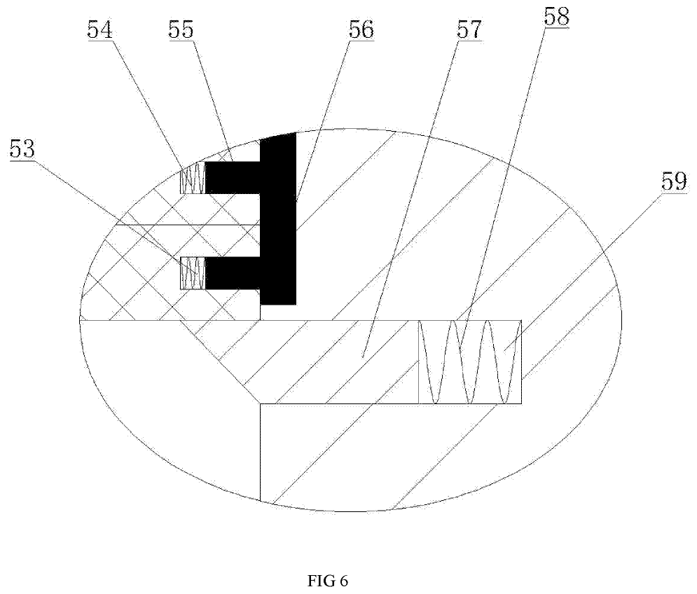

As shown in FIG. 1 to 6, an intelligent solar road lamp with charging function for municipal use according to the invention comprises a lamp post 10 and a charging cavity 27 disposed in the lamp post 10; charging electrodes 56 are symmetrically disposed in both end walls of the charging cavity 27; an inlet 28 and an outlet 26 are disposed in a first side wall of the charging cavity 27; first sliding holes 59 are symmetrically disposed in the both end walls of the charging cavity 27; first sliding rods 57 are disposed in the first sliding holes 59; first springs 58 are elastically disposed between the first sliding rods 57 and end walls of the first sliding holes 59; multiple groups of portable batteries 51 are stacked on the first sliding rods 57; grooves 53 with outward openings are disposed in both end walls of the portable batteries 51; contacting electrodes 55 abutted against the charging electrodes 56 are disposed in the grooves 53; second springs 54 are elastically disposed between the contacting electrodes 55 and end walls of the grooves 53; power indicator lights 50 are symmetrically disposed on front and rear end walls of the portable batteries 51; a color sensor 52 is disposed in a rear wall of the charging cavity 27; a pushing block 30 is disposed in the charging cavity 27; a sliding groove 36 with an upward opening is disposed in a bottom wall of the charging cavity 27; a rack 35 fixedly connected to the pushing block 30 is disposed in the sliding groove 36; a first reset device 34 is elastically disposed between the rack 35 and an end wall of the sliding groove 36; a gear cavity 31 is disposed in a first wall of the sliding groove 36; a first belt cavity 60 is disposed in a rear wall of the gear cavity 31; a first rotating shaft 32 is rotatably disposed between the first belt cavity 60 and the gear cavity 31; a sector gear 33 is fixedly disposed on a first tail end of the first rotating shaft 32 in the gear cavity 31; a first pulley 45 is fixedly disposed on a second tail end of the first rotating shaft 32 in the first belt cavity 60; a rotating cavity 24 is disposed in a top wall of the charging cavity 27; a second belt cavity 39 is disposed in a rear wall of the rotating cavity 24; a second rotating shaft 49 is rotatably disposed between the second belt cavity 39 and the rotating cavity 24; a second pulley 37 is fixedly disposed on a first tail end of the second rotating shaft 49 in the second belt cavity 39; roller wheels 25 are symmetrically disposed on a second tail end of the second rotating shaft 49 in the rotating cavity 24; in use, the roller wheels 25 rotate to push the portable batteries 51 out of the outlet 26.

Beneficially, a swing cavity 29 is disposed in a bottom wall of the inlet 28; a ratchet cavity 61 is disposed between the first belt cavity 60 and the second belt cavity 39; a third rotating shaft 41 is rotatably disposed between the first belt cavity 60 and the ratchet cavity 61; a third pulley 42 is fixedly disposed on a tail end of the third rotating shaft 41 in the first belt cavity 60; the third pulley 42 is in transmissive fit connection with the first pulley 45 through a first belt 44; a fourth rotating shaft 46, which penetrates the second belt cavity 39, is rotatably disposed between the ratchet cavity 61 and the swing cavity 29; a fourth pulley 40 is fixedly disposed on an outer surface of the fourth rotating shaft 46 in the second belt cavity 39; the fourth pulley 40 is in transmissive fit connection with the second pulley 37 through a second belt 38; a toggling rod 48 is fixedly disposed on an outer surface of the fourth pulley 40 in the swing cavity 29; a torsion spring 47 is elastically connected between a front end of the fourth pulley 40 and a front wall of the swing cavity 29; the fourth pulley 40 in the ratchet cavity 61 is connected to the third rotating shaft 41 through a ratcheting device 43; in use, when the portable batteries 51 are abutted against the toggling rod 48, the toggling rod 48 rotates to a first side to provide power for a charging device.

Beneficially, a stabilizing base 11 is fixedly disposed on a bottom wall of the lamp post 10; a battery 18 is disposed in the lamp post 10; a floodlight 13 and a lampshade 12 are fixedly disposed on a top wall of the lamp post 10; a transmission cavity 14 is disposed in the lamp post 10; a worm 16, which is in power connection with a motor 17 fixedly disposed in a bottom wall of the transmission cavity 14, is rotatably disposed in the transmission cavity 14; a fifth rotating shaft 23 extending in front-rear direction is rotatably disposed in the transmission cavity 14; a worm wheel 15 engaged with the worm 16 is fixedly disposed on an outer surface of the fifth rotating shaft 23 in the transmission cavity 14; front and rear tail ends of the fifth rotating shaft 23 extend out of the lamp post 10, wherein swing rods 22 are fixedly disposed on the front and rear tail ends of the fifth rotating shaft 23; a fixing plate 20 is fixedly disposed between two of the swing rods 22 in front-rear direction; a solar panel 19 is fixedly disposed on a top wall of the fixing plate 20; a reflector panel 21 is fixedly disposed on a bottom wall of the fixing plate 20; in use, the motor 17 is started to rotate to drive the worm 16, the worm wheel 15, the swing rods 22 and the fixing plate 20 to swing, thereby adjusting an angle of the solar panel 19 or the reflector panel 21.

Next, the applicant will give a detailed description of the workflow by referring to FIG. 1-6 attached and the specific composition of the intelligent solar road lamp with charging function for municipal use described above:

when it is in daytime, the solar panel 19 receives light and generates electricity to store in the battery 18, and at the same time, the motor 17 is started to rotate to drive the worm 16, the worm wheel 15, the swing rods 22 and the fixing plate 20 to swing, thus the solar panel 19 is driven to follow the sunlight to adjust the angle, thus generation efficiency of the solar panel 19 is improved; when it is in the night, the floodlight 13 is turned on to provide light, and at the same time, the motor 17 is able to be started to rotate to drive the worm 16, the worm wheel 15, the swing rods 22 and the fixing plate 20 to swing, thereby driving the reflector panel 21 to swing, thus adjusting an illumination area; when using the device for charging, one of the portable batteries 51 which is already used is put into the device through the inlet 28, and when the one of the portable batteries 51 abuts against the toggling rod 48, the toggling rod 48 rotates to the first side, thereby driving the fourth rotating shaft 46 to rotate, thus driving the torsion spring 47 to store force; at the same time, the fourth pulley 40, the second pulley 37 and the roller wheels 25 are driven to rotate, and then the one of the portable batteries 51 which is charged is pushed out of the outlet 26; when the one of the portable batteries 51 which is already used separates from the toggling rod 48 and falls on the pushing block 30, the fourth rotating shaft 46 reverses under an action of the torsion spring 47, thus the ratcheting device 43, the third pulley 42, the first pulley 45 and the sector gear 33 are driven to rotate, and the rack 35 is driven to move upward, and the pushing block 30 and the one of the portable batteries 51 which is already used are moved upward to an upper position of the first sliding rods 57; at this time, the sector gear 33 separates from the rack 35, and the rack 35 and the pushing block 30 moves downward; the contacting electrodes 55 on both sides of the one of the portable batteries 51 which is already used are abutted against the charging electrodes 56 for charging; when the one of the portable batteries 51 which is already used moves upward, all the portable batteries 51 in the charging cavity 27 move upward for a lattice, and at this time, the color sensor 52 analyzed and judged one of the power indicator lights 50 of a second one, which is from top to bottom, of the portable batteries 51, and when the one of the power indicator lights 50 is green, the inlet 28 is opened; when the one of the power indicator lights 50 is red, the inlet 28 is closed.

Through the detailed analysis above, it shows that the device of the invention is able to adjust the angle of the solar panel, thereby improving the power generation efficiency of the device, and at the same time, the device is able to adjust the angle of the reflector panel, thereby adjusting the lighting area. The device is equipped with a charging device, which is able to conveniently provide charging rental service of the portable batteries.

The above is only the specific embodiment of the present invention, but the protection scope of the present invention is not limited thereto, and any changes or substitutions without creative efforts shall fall within the protection scope of the present invention. Therefore, the claimed protection extent of the invention shall be determined with reference to the appended claims.

1. An intelligent solar road lamp with charging function for municipal use, comprising a lamp post and a charging cavity disposed in the lamp post;
charging electrodes symmetrically disposed in both end walls of the charging cavity;
an inlet and an outlet disposed in a first side wall of the charging cavity;
first sliding holes symmetrically disposed in the both end walls of the charging cavity;
first sliding rods disposed in the first sliding holes;
first springs elastically disposed between the first sliding rods and end walls of the first sliding holes;
multiple groups of portable batteries stacked on the first sliding rods;
grooves with outward openings disposed in both end walls of the portable batteries;
contacting electrodes abutted against the charging electrodes 56 disposed in the grooves;
second springs elastically disposed between the contacting electrodes and end walls of the grooves;
power indicator lights symmetrically disposed on front and rear end walls of the portable batteries;
a color sensor disposed in a rear wall of the charging cavity;
a pushing block disposed in the charging cavity;
a sliding groove with an upward opening disposed in a bottom wall of the charging cavity;
a rack fixedly connected to the pushing block disposed in the sliding groove;
a first reset device elastically disposed between the rack and an end wall of the sliding groove;
a gear cavity disposed in a first wall of the sliding groove;
a first belt cavity disposed in a rear wall of the gear cavity;
a first rotating shaft rotatably disposed between the first belt cavity and the gear cavity;
a sector gear fixedly disposed on a first tail end of the first rotating shaft in the gear cavity;
a first pulley fixedly disposed on a second tail end of the first rotating shaft in the first belt cavity;
a rotating cavity disposed in a top wall of the charging cavity;
a second belt cavity disposed in a rear wall of the rotating cavity;
a second rotating shaft rotatably disposed between the second belt cavity and the rotating cavity;
a second pulley fixedly disposed on a first tail end of the second rotating shaft in the second belt cavity;
roller wheels symmetrically disposed on a second tail end of the second rotating shaft in the rotating cavity;
in use, the roller wheels rotate to push the portable batteries out of the outlet.

2. The intelligent solar road lamp with charging function for municipal use as defined in claim 1, wherein a swing cavity is disposed in a bottom wall of the inlet;
a ratchet cavity is disposed between the first belt cavity and the second belt cavity;
a third rotating shaft is rotatably disposed between the first belt cavity and the ratchet cavity;
a third pulley is fixedly disposed on a tail end of the third rotating shaft in the first belt cavity;
the third pulley is in transmissive fit connection with the first pulley through a first belt;
a fourth rotating shaft, which penetrates the second belt cavity, is rotatably disposed between the ratchet cavity and the swing cavity;
a fourth pulley is fixedly disposed on an outer surface of the fourth rotating shaft in the second belt cavity;
the fourth pulley is in transmissive fit connection with the second pulley through a second belt;
a toggling rod is fixedly disposed on an outer surface of the fourth pulley in the swing cavity;
a torsion spring is elastically connected between a front end of the fourth pulley and a front wall of the swing cavity;
the fourth pulley in the ratchet cavity is connected to the third rotating shaft through a ratcheting device;
in use, when the portable batteries are abutted against the toggling rod, the toggling rod rotates to a first side to provide power for a charging device.

3. The intelligent solar road lamp with charging function for municipal use as defined in claim 1, wherein a stabilizing base is fixedly disposed on a bottom wall of the lamp post;
a battery is disposed in the lamp post;
a floodlight and a lampshade are fixedly disposed on a top wall of the lamp post;
a transmission cavity is disposed in the lamp post;
a worm, which is in power connection with a motor fixedly disposed in a bottom wall of the transmission cavity, is rotatably disposed in the transmission cavity;
a fifth rotating shaft extending in front-rear direction is rotatably disposed in the transmission cavity;
a worm wheel engaged with the worm is fixedly disposed on an outer surface of the fifth rotating shaft in the transmission cavity;
front and rear tail ends of the fifth rotating shaft extend out of the lamp post, wherein swing rods are fixedly disposed on the front and rear tail ends of the fifth rotating shaft;
a fixing plate is fixedly disposed between two of the swing rods in front-rear direction;
a solar panel is fixedly disposed on a top wall of the fixing plate;
a reflector panel is fixedly disposed on a bottom wall of the fixing plate;
in use, the motor is started to rotate to drive the worm, the worm wheel, the swing rods and the fixing plate to swing, thereby adjusting an angle of the solar panel or the reflector panel.
